(19) United States
(12) Patent Application Publication
(10) Pub. No.: US 2023/0289884 A1
(43) Pub. Date: Sep. 14, 2023

(54) CONTROL ASSESSMENT MANAGEMENT SYSTEM

(71) Applicant: SECURITY CAMP INC., Sejong (KR)

(72) Inventors: Myung Hoon PARK, Sejong (KR); Dong Kyu SEO, Sejong (KR)

(21) Appl. No.: 18/043,720

(22) PCT Filed: Oct. 30, 2020
(86) PCT No.: PCT/KR2020/015031

§ 371 Date: Mar. 1, 2023

(30) Foreign Application Priority Data
Sep. 2, 2020 (KR) 10-2020-0111827

(51) Int. Cl. G06Q 40/06; G06Q 50/18

(52) U.S. Cl. CPC G06Q 40/06; G06Q 50/18

(57) ABSTRACT

Provided is a control assessment management system including: a storage configured to store, as action items, control items required by laws and by compliances related to basic information and asset information of a company; an information input unit configured to receive basic information and asset information of a company to be evaluated, wherein the basic information includes general information, security duties, and organizational charts of the company, and the asset information includes information assets and personal information assets owned by the company to be evaluated; a processor configured to extract evaluation items from among the action items based on the basic information and the asset information; a result input unit configured to receive a control assessment result for each of the evaluation items; and an output unit configured to output a defective control item derived by the processor based on the control assessment result.

### BACKGROUND

### Technical Field

The present disclosure relates to a control assessment management system, and more particularly, a control assessment management system for suggesting control items suitable for a business field of a company to efficiently respond to various domestic and foreign compliances, and for easily checking compliance to the control items.

### Background Art

Compliance refers to a series of activities to control and supervise in advance or regularly a company's executives and employees so that they can comply with relevant laws and regulations. In a broad sense, the compliance may be regarded as including not only compliance with laws and regulations, but also compliance with corporate internal regulations, guidelines, and integrity, such as corporate ethical management. The scope of compliance covers all laws and regulations related to corporate activities. For example, for a corporation, the scope of compliance may cover the Commercial Act, the Unfair Competition Prevention Act, the Personal Information Protection Act, and the Information and Communications Network Act. The compliance may include not only these domestic laws, but also various management system certifications suggested by the International Organization for Standardization (ISO).

In recent years, the importance of compliance is growing day by day as the business of a company diversifies and the amount of information to be dealt with increases exponentially. In addition, as companies need to frequently interact with customers online, it is necessary to handle information on the customers. Also, since the customers' personal information is sensitive, the company's internal control of the information has become more and more necessary.

However, despite the growing need for the internal control, the reality is that many companies lack awareness of compliance and that compliance is only conducted by experts. This is because when a company attempts to run a certain business, there are various compliances related to the business, so it is difficult for a company to find a number of control items suggested by the various compliances and to check whether the control items are complied with.

### RELATED DOCUMENT

US Patent Application Publication No. 2008-0015913

(Publication Date: Jan. 17, 2008, Title of Invention: Global compliance management system)

### DETAILED DESCRIPTION OF THE INVENTION

### Technical Challenge

The present disclosure provides a control assessment management system for selecting and suggesting control items that a company should comply with in response to various domestic and foreign compliances as control items suitable for a business field the company.

The present disclosure also provides a control assessment management system for selecting and suggesting control items to be complied with by a company, without an auditor's professional knowledge.

The present disclosure also provides a control assessment management system for visually checking and improving whether or not a company is in good compliance with required control items.

### SUMMARY

In an aspect, there is provided a control assessment management system including: a storage configured to store, as action items, control items required by laws and by compliances related to basic information and asset information of a company; an information input part configured to receive basic information and asset information of a company to be evaluated, wherein the basic information includes general information, security duties, and organizational charts of the company, and the asset information includes information assets and personal information assets owned by the company to be evaluated; a processor configured to extract evaluation items from among the action items based on the basic information and the asset information; a result input unit configured to receive a control assessment result for each of the evaluation items; and an output unit configured to output a defective control item derived by the processor based on the control assessment result. The processor is further configured to: assign an identification code to each action item to identify a corresponding action item; in response to action items having a same or similar content among the action items, map identification codes of the action items; and store a result of the mapping in the storage

The processor may extract the evaluation items according to information as to whether or not to acquire a certification, the information received by the information input unit.

The processor may extract an evaluation item by selecting a representative item from among action items having a same or similar content based on the result of the mapping.

The storage may include: a certification control item DB in which control items required by the compliance are subdivided and stored as action items; and a legal control item DB in which control items required by the laws are subdivided and stored them as action items.

The processor may be further configured to: receive legal information at regular intervals from a server that provides information on domestic or foreign laws; and in response to change, addition, or deletion occurring in the legal information, update the action items corresponding to the legal information and store the updated action items in the storage.

The information input unit may receive operational evidences corresponding to the action items.

The information input unit may receive a Degree of assurance (DoA), the processor may extract asset-specific protection measures for the information assets or the personal information assets based on the DoA, and the output unit may output the asset-specific protection measures.

In another aspect of the present disclosure, there is provided a control assessment management method including: a first operation in which a storage subdivides and storing, as at least one action item, control items required by laws and by compliances related to basic information and asset information of a company; a second operation in which the processor assigns an identification code to each action item to identify a corresponding action item and, in response to action items having a same or similar content among the action items, maps identification codes of the action items and stores a result of the mapping in the storage; a third operation in which an information input unit receives basic information and asset information of a company to be evaluated, wherein the basic information includes general information, security duties, and organizational charts of the company and the asset information includes information assets and personal information assets owned by the company; a fourth operation in which the processor extracts evaluation items from among the action items based on the basic information and the asset information; a fifth operation in which a result input unit receives a control assessment result for each of the evaluation items; and a sixth operation in which an output unit outputs a defective control item derived by the processor based on the control assessment result.

The fourth operation may further include extracting the evaluation items according to information as to whether to acquire a certification, the information received by the information input unit.

The second operation may further include extracting, by the processor, an evaluation item by selecting a representative item from among action items having a same or similar content based on the result of mapping.

In the first operation, the storage may include a certification control item DB in which control items required by the compliance are subdivided and stored as action items, and a legal control item DB in which control items required by the laws are subdivided and stored as action items.

In the second operation, the processor may receive legal information at regular intervals from a server providing information on domestic or foreign laws and, in response to change, addition, or deletion occurring in the legal information, update the action items corresponding to the legal information and store the updated action items in the storage.

The third operation may further include receiving, by the information input unit, operational evidences corresponding to the action items.

The third operation may further include: receiving, by the information input unit, a Degree of assurance (DoA); extracting, by the processor, asset-specific protection measures for the information assets or the personal information assets based on the DoA; and outputting, by the output unit, the asset-specific protection measures.

### Effects of the Invention

The control assessment management system according to an embodiment of the present disclosure can select and suggest control items that a company should comply with in response to various domestic and foreign compliances as control items suitable for a business field the company.

In addition, the control assessment management system according to an embodiment of the present disclosure can selecting and suggesting control items to be complied with by a company, without an auditor's professional knowledge.

In addition, the control assessment management system according to an embodiment of the present disclosure can visually check and improve whether or not a company is in good compliance with required control items.

### BRIEF DESCRIPTION OF THE DRAWINGS

FIG. 1 is a diagram showing an example of an operating environment of a control assessment management system according to an embodiment of the present disclosure.

FIG. 2 is a conceptual diagram of a control assessment management system according to an embodiment of the present disclosure.

FIG. 3 is a flowchart illustrating that a method for control assessment management is performed between a control assessment management system and a user terminal according to an embodiment of the present disclosure.

FIG. 4 is a diagram illustrating that the control assessment management system according to an embodiment of the present disclosure is connected to a legal information server to receive legal information.

FIG. 5 is a diagram showing that a processor classifies control items presented in ISMS-P into action items according to an embodiment of the present disclosure.

FIG. 6 is a diagram showing vulnerability check items provided to a user by a control assessment management system according to an embodiment of the present disclosure.

FIG. 7 is a diagram showing that a processor classifies control items, presented by the law, according to an embodiment of the present disclosure.

### DESCRIPTION OF EXEMPLARY EMBODIMENTS

Hereinafter, embodiments of the present disclosure will be described in detail with reference to the accompanying drawings. In describing the present disclosure, if it is determined that a detailed description of known functions and components associated with the present disclosure unnecessarily obscure the gist of the present disclosure, the detailed description thereof will be omitted. The terms used henceforth are used to appropriately express the embodiments of the present disclosure and may be altered according to a person of a related field or conventional practice. Therefore, the terms should be defined on the basis of the entire content of this specification.

Therefore, the terms should be defined on the basis of the entire content of this specification. The singular forms used in the present invention include plural forms as long as the phrases do not clearly have a contrary sense. The meaning of “including” used in the specification specifies a specific characteristic, area, integer, step, action, element, and/or component, but it is not considered to eliminate the existence or addition of other characteristics, areas, integers, steps, actions, elements, and/or components.

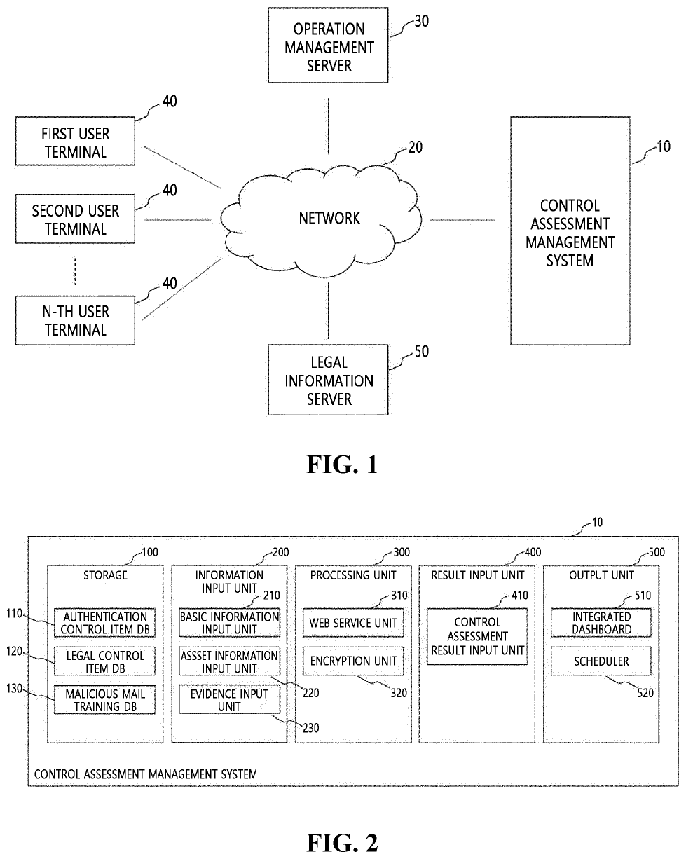

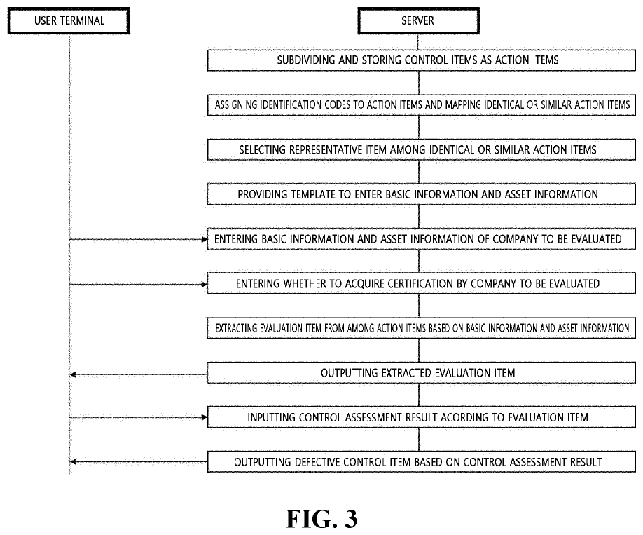

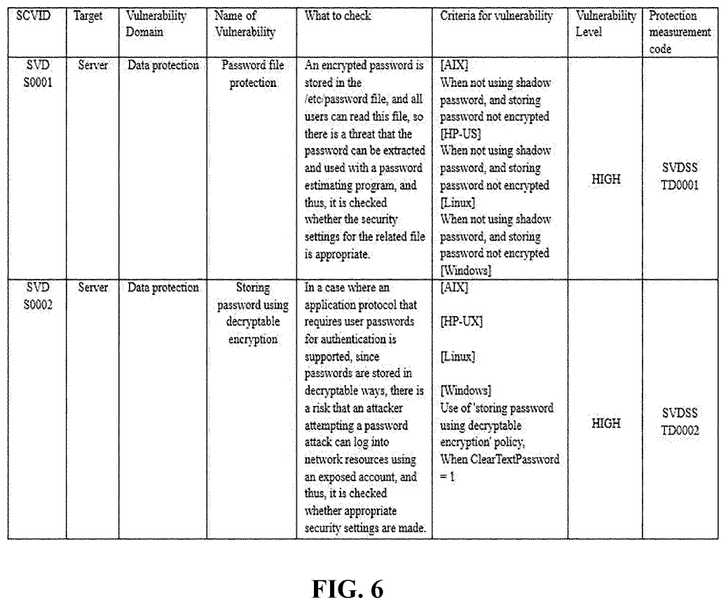

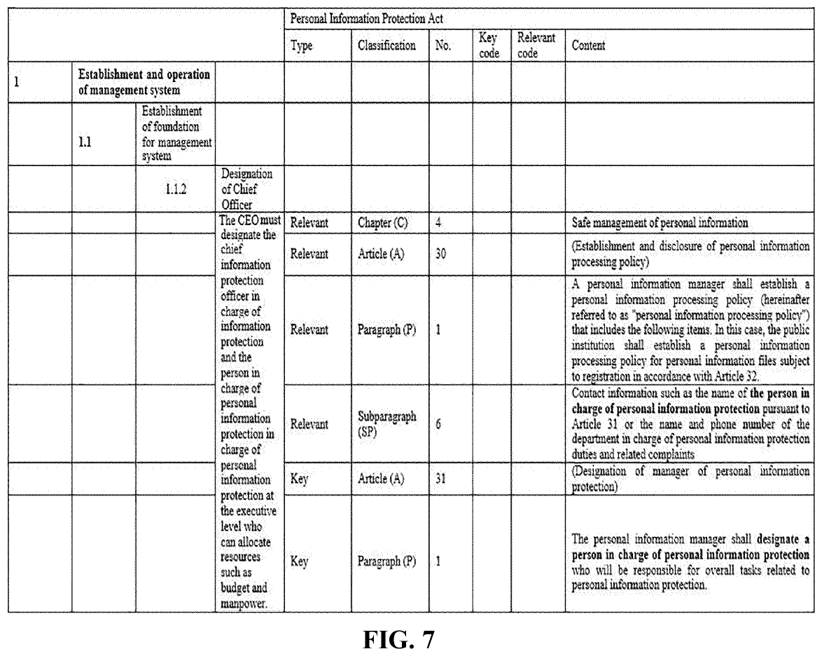

Hereinafter, a control assessment management system 10 according to an embodiment of the present disclosure will be described with reference to FIGS. 1 to 7.

The control assessment management system 10 according to an embodiment of the present disclosure is a system that selects and provides a compliance to be complied with by a company according to a business field operated by the company from among various domestic and foreign compliances and then checks whether or not the company properly complies with required control items in the corresponding compliance. The control assessment management system 10 may suggest compliance and control items that are requested to the company or to be complied with by the company according to the input of the company's basic information and asset information by the person in charge of the company, which is the user. The company may check whether the control items presented by the control assessment management system 10 are properly complied with, and may input an operational evidence into the control assessment management system 10 as a result. The control assessment management system 10 may determine which one of the control items are well complied with based on the input control assessment result. Then, the control assessment management system 10 may specifically present defective control items and a control item necessary to be improved by the company in the future. In doing so, the company may be able to check and confirm required compliance control items and strengthen an internal control without the help of external experts.

FIG. 1 is an example showing an operating environment of the control assessment management system 10 according to an embodiment of the present disclosure. The control assessment management system 10 may be connected to a network 20 such as the Internet. A user terminal 40, an operation management server 30, and a legal information server 50 may communicate with each other via the network 20. The user terminal 40 refers to any of various terminals such as a PC, tablet PC, and smart phone that allow a person in charge of the company or an external auditor to access the control assessment management system 10. The operation management server 30 may be connected to the control assessment management system 10 via the network 20 to perform maintenance and update of the control assessment management system 10. As described later, the legal information server 50 is a server that provides information on domestic or international laws, and may serve to transmit legal information to be complied with by companies to the control assessment management system 10. FIG. 1 is an example for explanation of the present disclosure, and the number of user terminals 40 or control assessment management systems 10 is not limited as shown in FIG. 1.

Hereinafter, each configuration of the control assessment management system according to an embodiment of the present disclosure will be described with reference to FIGS. 2 to 7.

The control assessment management system 10 of the present disclosure may include a storage 100 configured to subdividing and storing control items as action items, an information input unit 200 for receiving basic information and asset information on the company, a processor 300 for extracting evaluation items from action items, a result input unit 400 for receiving control assessment results, and an output unit 500 for outputting a defective control item.

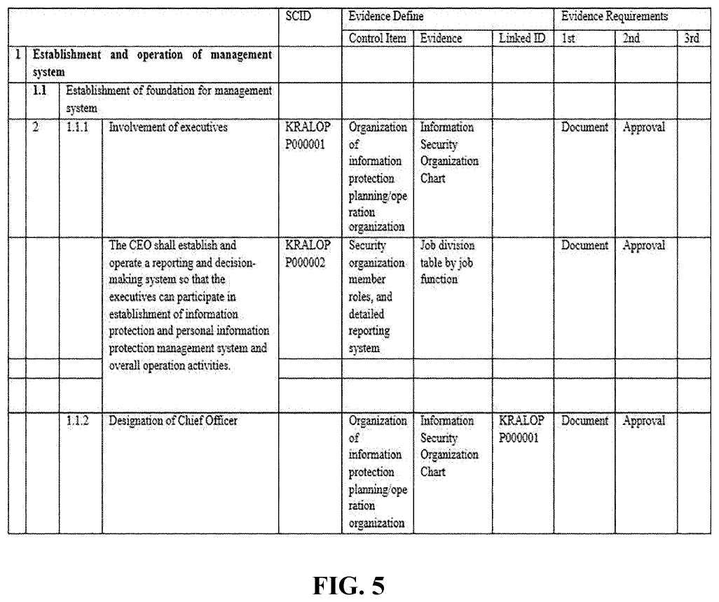

The storage 100 may include an certification control item DB 110 for storing certification-related control items, a legal control item DB 120 for storing law-related control items, and a malicious mail training DB 130 for storing data-related to malicious mail training. The storage 100 may subdivide control items required by laws and compliance related to basic information and asset information of a company, and store the control items as at least one action item. The basic information of the company is information that includes all general information on the company, such as a business field the company is operating, the company's sales, the number of employees, security duties, and organization chart. Based on the basic information of the company, the control assessment management system 10 may be able to grasp the size and business field of the company. Asset information of a company refers to both physical and non-physical assets owned by the company. That is, the assent information may include both physical assets such as servers, devices of the network 20, databases, and security systems, and non-physical assets such as information assets, personal information assets, or software. Control items refer to detailed control contents required by domestic and international compliance, and refer to matters that must be legally or normatively followed in order for a company to conduct business. However, there may be cases where these control items are not broad in scope or specific. In this case, without the advice of experts, such as auditors, the company is not able to specifically comply with the details required by the control items. Therefore, it is necessary to further subdivide the control items and suggest specific action guidelines to the company. In order to solve the problem, the storage 100 may store the action items in which the control items are specifically subdivided. FIG. 5 shows control items and action items of the ISMS-P stored in the storage 100 in a table form.

The storage 100 may separately store action items in the legal control item DB 120 and the certification control item DB 110 according to the following criteria. That is, action items according to control items required by laws may be stored in the legal control item DB 120, and action items according to control items required by non-legal compliance may be stored in the certification control item DB 110.

The storage 100 may include the malicious mail training DB 130 that stores a training target, contents of malicious mails, and training results for corporate malicious mail response training. The training target may include the name and e-mail of the target subject to malicious mail response training. The content of a malicious mail may include the body of the malicious mail and a file attached to the mail. The malicious mail training DB 130 may store information on a result of transmission of a malicious mail that is, whether the transmission has been successful, whether the malicious mail has been viewed, whether a malicious link has been clicked, and the like. Through the data stored in the malicious mail training DB 130, the company's security manager may conduct training on malicious mails for company insiders. For example, the corporate security officer may inquire malicious mail training plans stored in the storage 100 and determine whether to execute the malicious mail training according to the plan. In addition, the control assessment management system 10 may transmit a training schedule according to the malicious mail training plan to a corporate security manager. When it is decided whether to conduct the training or not, the corporate security manager may determine a type, object, method, or scenario of the training and store the determined type, object, method, or scenario of the training in the malicious mail training DB 130. Based on training data stored in the malicious mail training DB 130 in the above manner, the control assessment management system 10 conducts the malicious mail training by sending spam mails to people subject to the training.

The information input unit 200 may include a basic information input unit 210 for receiving basic information on the company, an asset information input unit 220 for receiving an input of asset information on the company, and an operational evidence input unit 230 for receiving an operational evidence. Using a predetermined template, the information input unit 200 may receive basic information including a company's general information, security duties, and organizational charts, and asset information including the company's information assets and personal information assets.

The information input unit 200 may receive, from the company, information as to whether to acquire and operate a certification. Here, certification refers to various certifications required for the company to run a business. Representative examples of certification may include ISMS and ISO27001, which are related to information security, and ISMS-P, ISO27701, and BS10012, which are related to personal information protection. The information input unit 200 receives from the company information as to whether to acquire and operate a certification. When the received information is Yes (which means to acquire certification), the information input unit 200 provides a template, receive detailed certification service information (certification status, certification scope), and stores detailed certification service information in the storage 100. On the other hand, when the received information is No (which means not to acquire certification), internal security standard may be entered using a different template depending on whether the internal security standard exists. For example, when the internal security standard exists, a template is provided to enter the contents of the company's security standards (policies, guidelines, and procedures), and when the internal security standard does not exist, an exemplary sample may be provided for the company to refer to when entering the security standard.

The information input unit 200 may receive an operational evidence corresponding to an action item. In some cases, the action item requires an operational evidence to confirm whether the action item is complied with. By receiving the operational evidence, the control assessment management system 10 may determine whether the company has complied with the are no corresponding control item, and may also derive a control item with no operational evidence input among control items as defective. A detective control item will be described in detail later.

The information input unit 200 may receive a degree of assurance (DoA). The DoA, which refers to a degree of risk acceptance, is one of the risk response strategies to support the selection of an appropriate information protection measure and the securing of priorities to manage a risk of information assets. In other words, it is to determine the acceptable risk level for a risk that is found as a result of risk analysis. How to establish an information protection measure depends on the level of risk determined by the company. By receiving the DoA, the control assessment management system 10 may establish a protection measure for each asset. In this case, the established protection measure for each asset may be output through an output unit 500 which will be described later, so that a corporate security management can check the established protection measure.

The processor 300 may include a Web Service unit 310 for providing a web service and an encryption unit 320 for encrypting personal information assets possessed by a company. The processor 300 allows a user to access the control assessment management system 10 of the present disclosure in the Web environment through the Web Service unit 310. In addition, the encryption unit 320 may encrypt personal information when a company has personal information, so that the encrypted personal information can be stored.

The processor 300 may extract evaluation items from action items based on basic information and asset information of the company. As described above, the action items stored in the storage 100 may include all action items corresponding to control items required by domestic and foreign compliance companies. It is not necessary for the companies to comply with all of these action items. This is because the compliance requirements to be complied with are different depending on a business field or assets held by each company. Therefore, it is necessary to extract only action items corresponding to control items that a company needs to comply with. The action items extracted in the above manner are evaluation items, and the evaluation items extracted by the processor 300 are stored in the storage 100.

The processor 300 may assign an identification code to each action item to identify a corresponding action item. When there are action items having a same or similar content among the action items, the processor 300 may map identification codes of the action items having a same or similar content, and store a result of the mapping in the storage 100. Control items required by compliance vary, but sometimes the contents of the control items may be almost the same. For control items having a same or similar content, action items may also have a same or similar content. For a company that needs to respond to multiple compliances, it is not necessary to comply with a same or similar action item, so compliance with one action item can be replaced with compliance with other overlapping action items. To this end, an identification code may be given to each action item to identify a corresponding action item, and identification codes may be mapped between the same or similar action items. A mapping result may be stored in the storage 100.

The processor 300 may extract an evaluation item by selecting a representative item from among action items having a same or similar content based on the mapping result. In a case where action items are mapped and a representative item is selected from among the action items, it is possible to comply with other mapped action items by complying with only the representative item. Thus, if the representative item is extracted as an evaluation item, there is no need for the company to double check compliance with the same content.

The processor 300 may extract an evaluation item according to information as to whether to acquire a certification, the information received by the information input unit 200. The company may determine whether to acquire and operate a certification among the compliances to comply with. If a company simply wishes to comply with control items without acquiring certification, the control items to be complied with may be different from a case where a company wishes to acquire acquisition for the control items to be complied with. Thus, if an evaluation item is extracted by checking information as to whether to acquire and operate a certification, it is possible to suggest evaluation items suitable for the company's situation.

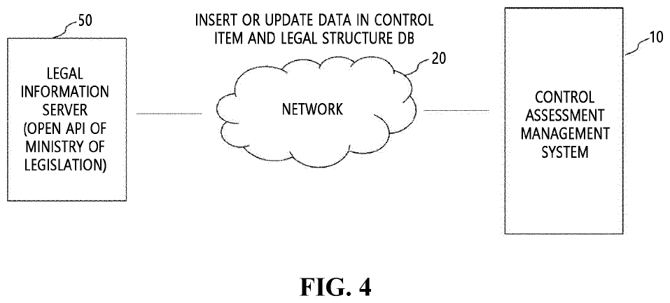

The processor 300 receives legal information at regular intervals from a server that provides information on domestic or foreign laws. When legal information has been changed, added, or deleted, the processor 300 may update an action item corresponding to the legal information and store the updated action item in the storage 100. As shown in FIG. 4, the legal information server 50 may be connected to the control assessment management system 10 via the network 20. The processor 300 may check the updated legal information in the legal information server 50 via the network 20. When there is new, revised, deleted, or added legal information, the processor may receive data corresponding to the content of the new, revised, deleted, or added legal information. The data received in this way may be stored in the legal control item DB 120. In doing so, the control assessment management system 10 may be able to store updated legal information and extract evaluation items in consideration of the updated legal information.

The processor 300 may extract an asset-specific protection measure for information assets or personal information assets based on a DoA. In addition, the processor 300 may derive an annual security operation plan based on the asset-specific protection measure.

The result input unit 400 may receive a control assessment result for an evaluation item through the control assessment result input unit 410. A security manager of the company or an external auditor may check the evaluation item extracted through the processor 300 and carry out a control assessment accordingly. The company's security manager carrying out the control assessment may input a result of the control assessment into the result input unit 400. The control assessment result input to the result input unit 400 may be transmitted to the processor 300, so that the processor 300 can derive a defective control assessment using the control assessment result.

The result input unit 400 may receive an audit conduction evidence, which is a result of information security audit, a training conduction evidence, which is a result of information security training, and a response training conduction evidence, which is a result of infringement accident training. Each evidence received by the result input unit 400 may be stored in the storage 100 and may be checked by a user through the output unit 500 as necessary.

The output unit 500 may include an integrated dashboard 510 for visualizing a risk of asset or outputting defective control assessment, and a scheduler 520 for checking or alerting a schedule related to internal control. The output unit 500 may visualize and output a risk of asset owned by the company through the integrated dashboard 510. Based on the visualized risk, the company may be able to efficiently and quickly identify the risk of asset owned by the company. The output unit 500 may output a schedule for an action item and a notification according to the schedule through the scheduler 520. Since the output unit 500 outputs scheduling and notification of a control item through the scheduler 520, a user may be able to grasp, through a display screen, what actions the company should take for internal control in the future.

The output unit 500 may output a defective control item derived by the processor 300 based on the control assessment result. As described above, when the result input unit 400 receives the control assessment result, the control assessment result is transmitted to the processor 300. Upon receiving the control assessment result, the processor 300 determines which control item is not being complied with based on control items or action items. In this case, the processor 300 may determine which control item is not being complied with, including operational evidences received by the information input unit 200. Thereafter, the processor 300 may derive a defective control item, and the result thereof may be output through the output unit 500. The output unit 500 may output the defective control item through the integrated dashboard 510 corresponding to a user UI. In doing so, it is possible to allow a user to determine which control item is currently not being complied with.

The output unit 500 may output an asset specific protection measure or annual security operation plan. Based on the asset-specific protection measures output by the output unit 500, the company may be able to devise a protection measure for each asset. Using the annual security operation plan output by the output unit 500 of the control assessment management system 10, the corporate security manager may be able to grasp the corporate security operation plan without a need to separately establish or manage a security operation plan.

The technical features disclosed in each embodiment of the present disclosure are not limited to a corresponding embodiment, and unless incompatible with each other, the technical features disclosed in each embodiment may be applied in combination to other embodiments.

In the above, the embodiments of the control assessment management system of the present disclosure have been described. The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.
10: Control Assessment Management System
20: Network
30: Operation Management Server
40: User Terminal
50: Legal Information Server
100: Storage
110: Certification Control Item DB
120: Legal Control Item DB
130: Malicious Mail Training DB
200: Information Input Unit
210: Basic Information Input Unit
220: Asset Information Input Unit
230: Operational Evidence Input Unit
300: Processor
310: Web Service Unit
320: Encryption Unit
400: Result Input Unit
410: Control Assessment Result Input Unit
500: Output Unit
510: Integrated Dashboard
520: Scheduler

1. A control assessment management system comprising:
a storage configured to store compliances being related to basic information and asset information of a company and control items required under the laws as action items;
an information input unit configured to receive basic information and asset information of a company to be evaluated, wherein the basic information comprises general information, security duties, and organizational charts of the company, and the asset information comprises information assets and personal information assets owned by the company to be evaluated;
a processor configured to extract evaluation items from the action items based on the basic information and the asset information;
a result input unit configured to receive a control assessment result for each of the evaluation items; and
an output unit configured to output a defective control item derived by the processor based on the control assessment result,
wherein the processor is further configured to:
assign an identification code to each action item to identify a corresponding action item;
in response to action items having a same or similar content among the action items, map identification codes of the action items; and
store a result of the mapping in the storage.

2. The control assessment management system of claim 1, wherein the processor extracts the evaluation items according to information as to whether or not to acquire a certification, the information received by the information input unit.

3. The control assessment management system of claim 1, wherein the processor extracts an evaluation item by selecting a representative item from among action items having a same or similar content based on the result of the mapping.

4. The control assessment management system of claim 1, wherein the storage comprises:
a certification control item DB in which control items required by the compliance are subdivided and stored as action items; and
a legal control item DB in which control items required by the laws are subdivided and stored them as action items.

5. The control assessment management system of claim 1, wherein the processor is further configured to:
receive legal information at regular intervals from a server that provides information on domestic or foreign laws; and
in response to change, addition, or deletion occurring in the legal information, update the action items corresponding to the legal information and store the updated action items in the storage.

6. The control assessment management system of claim 1, wherein the information input unit receives operational evidences corresponding to the action items.

7. The control assessment management system of claim 1, wherein:
the information input unit receives a Degree of assurance (DoA), and the processor extracts asset-specific protection measures for the information assets or the personal information assets based on the DoA, and
the output unit outputs the asset-specific protection measures.

8. A control assessment management method comprising:
a first operation in which a storage subdivides and storing, as at least one action item, control items required by laws and by compliances related to basic information and asset information of a company;
a second operation in which the processor assigns an identification code to each action item to identify a corresponding action item and, in response to action items having a same or similar content among the action items, maps identification codes of the action items and stores a result of the mapping in the storage;
a third operation in which an information input unit receives basic information and asset information of a company to be evaluated, wherein the basic information comprises general information, security duties, and organizational charts of the company and the asset information comprises information assets and personal information assets owned by the company;
a fourth operation in which the processor extracts evaluation items from among the action items based on the basic information and the asset information;
a fifth operation in which a result input unit receives a control assessment result for each of the evaluation items; and
a sixth operation in which an output unit outputs a defective control item derived by the processor based on the control assessment result.

9. The control assessment management method of claim 8, wherein the fourth operation further comprises extracting the evaluation items according to information as to whether to acquire a certification, the information received by the information input unit.

10. The control assessment management method of claim 8, wherein the second operation further comprises extracting, by the processor, an evaluation item by selecting a representative item from among action items having a same or similar content based on the result of mapping.

11. The control assessment management method of claim 8, wherein in the first operation, the storage comprises a certification control item DB in which control items required by the compliance are subdivided and stored as action items, and a legal control item DB in which control items required by the laws are subdivided and stored as action items.

12. The control assessment management method of claim 8, wherein in the second operation, the processor receives legal information at regular intervals from a server providing information on domestic or foreign laws and, in response to change, addition, or deletion occurring in the legal information, updates the action items corresponding to the legal information and stores the updated action items in the storage.

13. The control assessment management method of claim 8, wherein the third operation further comprises receiving, by the information input unit, operational evidences corresponding to the action items.

14. The control assessment management method of claim 8, wherein the third operation further comprises:
receiving, by the information input unit, a Degree of assurance (DoA);
extracting, by the processor, asset-specific protection measures for the information assets or the personal information assets based on the DoA; and
outputting, by the output unit, the asset-specific protection measures.
